(19) United States
(12) Patent Application Publication
(10) Pub. No.: US 2026/0336600 A1
(43) Pub. Date: Oct. 29, 2026

(54) VEHICLE CONTROL APPARATUS, VEHICLE CONTROL METHOD, AND VEHICLE CONTROL SYSTEM

(71) Applicant: Hitachi Astemo, Ltd., Ibaraki (JP)

(72) Inventors: Naoki SHINOHARA, Ibaraki (JP); Keisuke SUZUKI, Ibaraki (JP); Yasuaki SATO, Ibaraki (JP)

(21) Appl. No.: 19/107,889

(22) PCT Filed: Aug. 18, 2023
(86) PCT No.: PCT/JP2023/029820

§ 371 Date: Feb. 28, 2025

(30) Foreign Application Priority Data
Sep. 1, 2022 (JP) 2022-138912

(51) Int. Cl. B60W 30/02; B60W 10/04; B60W 10/184

(52) U.S. Cl. CPC B60W 30/02; B60W 10/04; B60W 10/184; B60W 2510/182; B60W 2520/10; B60W 2520/105; B60W 2710/182; B60W 2720/106

(57) ABSTRACT

A vehicle control apparatus changes a speed of a vehicle at which a control instruction intervenes based on a total braking torque, when outputting the control instruction for generating a driving force by a driving apparatus in a state that a frictional braking force is generated at the time of deceleration of the vehicle based on the total braking torque.

### TECHNICAL FIELD

The present invention relates to a vehicle control apparatus, a vehicle control method, and a vehicle control system.

### BACKGROUND ART

PTL 1 discloses a technique that acquires a physical quantity relating to a speed of a vehicle and a physical quantity relating to a requested braking force required to decelerate the vehicle and generates a driving force by a driving device under a state in which a friction braking force is being generated when the vehicle is to be decelerated based on the physical quantity relating to the requested braking force with the aim of suppressing a pitching fluctuation that occurs just before the vehicle stops.

### CITATION LIST

### Patent Literature

PTL 1: Japanese Patent Application Laid-Open No. 2022-056583

### SUMMARY OF INVENTION

### Technical Problem

However, the above-described conventional vehicle control apparatus increases the driving force as the vehicle speed reduces, but starts generating the driving force at a speed consistently kept at a constant value regardless of the magnitude of the requested braking force, thereby involving a risk of a failure to effectively realize a smooth vehicle stop.

One of objects of the present invention is to provide a vehicle control apparatus, a vehicle control method, and a vehicle control system capable of realizing a smooth vehicle

### Solution to Problem

According to one aspect of the present invention, a vehicle control apparatus changes a physical quantity relating to a speed of a vehicle at which a control instruction intervenes based on a physical quantity relating to a total braking force, when outputting the control instruction for generating a driving force by a driving apparatus in a state that a frictional braking force is generated at the time of deceleration of the vehicle based on the physical quantity relating to the total braking force.

According to the one aspect of the present invention, the smooth vehicle stop can be realized.

### BRIEF DESCRIPTION OF DRAWINGS

FIG. 1 schematically illustrates an electric vehicle 1 including a vehicle control system according to a first embodiment.

FIG. 2 is a control block diagram of a rear motor 7 according to the first embodiment.

FIG. 3 is a control block diagram of a total braking torque calculation portion 34 according to the first embodiment.

FIG. 4 is a control block diagram of a control gain calculation portion 35 according to the first embodiment.

FIG. 5 is a control block diagram of an added torque calculation portion 37 according to the first embodiment.

FIG. 6 illustrates a gain characteristic of a speed-based control gain map 53 according to the first embodiment.

FIG. 7 illustrates the gain characteristic of the speed-based control gain map 53 with respect to a vehicle speed according to the first embodiment.

FIG. 8 illustrates time charts of the vehicle speed, a rear motor torque, and a vehicle longitudinal acceleration according to a comparison example.

FIG. 9 illustrates time charts of the vehicle speed, the rear motor torque, and the vehicle longitudinal acceleration in anti-jerk control according to the first embodiment.

FIG. 10 illustrates a gain characteristic of the speed-based control gain map 53 according to a second embodiment.

FIG. 11 illustrates a gain characteristic of the speed-based control gain map 53 according to a third embodiment.

FIG. 12 illustrates the gain characteristic of the speed-based control gain map 53 with respect to the vehicle speed according to the third embodiment.

FIG. 13 is a control block diagram of a frictional brake 3 according to a fourth embodiment.

FIG. 14 is a control block diagram of a total braking torque calculation portion 73 according to the fourth embodiment.

FIG. 15 is a control block diagram of a subtracted braking force calculation portion 74 according to the fourth embodiment.

FIG. 16 illustrates time charts of the vehicle speed, a braking torque, and the vehicle longitudinal acceleration when a disturbance does not occur in the anti-jerk control according to the fourth embodiment.

FIG. 17 illustrates time charts of the vehicle speed, the braking torque, and the vehicle longitudinal acceleration when the disturbance occurs in the anti-jerk control according to the fourth embodiment.

### DESCRIPTION OF EMBODIMENTS

### First Embodiment

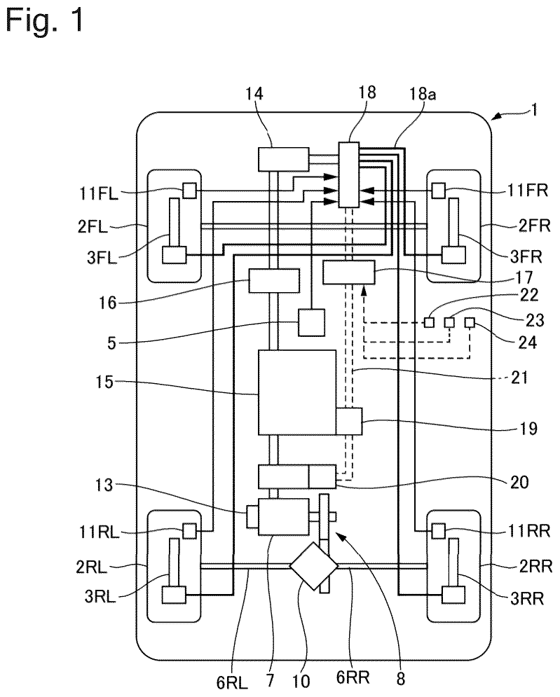

FIG. 1 schematically illustrates an electric vehicle 1 including a vehicle control system according to a first embodiment.

The electric vehicle 1 includes front wheels 2FL and 2FR and rear wheels 2RL and 2RR, and frictional brakes (frictional braking apparatuses) 3FL, 3FR, 3RL, and 3RR mounted on the respective wheels and configured to generate frictional braking forces on the respective wheels (hereinafter, the frictional brakes of the respective wheels will also be collectively referred to as a frictional brake 3).

The electric vehicle 1 includes a rear motor (a driving apparatus) 7, which outputs a torque to the rear wheels 2RL and 2RR. The rear wheels 2RL and 2RR will also be collectively referred to as a drive wheel 2. Power is transmitted between the rear motor 7 and the rear wheels 2RL and 2RR via a reducing gear 8, a differential 10, and rear axles 6RL and 6RR.

The wheels 2FL, 2FR, 2RL, and 2RR include wheel speed sensors 11FR, 11FL, 11RL, and 11RR, which detect wheel speeds, respectively. The rear motor 7 includes a rear-wheel resolver 13, which detects a motor rotational speed. Further, the electric vehicle 1 includes a G sensor 5, which detects a longitudinal acceleration (hereinafter also simply referred to as an acceleration) of the vehicle.

The frictional brake 3 generates the braking force based on a frictional force by pressing brake pads against a brake rotor integrally rotating with each wheel in a direction along a rotational axis of each wheel. The frictional brake 3 according to the first embodiment will be described as being configured to press the brake pads using a wheel cylinder actuated by a brake hydraulic pressure, but may be configured to press the brake pads via, for example, a ball screw mechanism driven by an electric motor and is not especially limited.

The electric vehicle 1 includes a low-voltage battery 14 and a high-voltage battery 15. The low-voltage battery 14 is, for example, a lead storage battery. The high-voltage battery 15 is, for example, a lithium ion battery or a nickel hydrogen battery. The high-voltage battery 15 is charged by electric power whose voltage is increased by a DC-DC converter 16.

The electric vehicle I includes a vehicle control apparatus (a control portion) 17, a brake control apparatus 18, a rear motor control apparatus 20, and a battery control apparatus 19. These control apparatuses 17, 18, and 20 share information with one another via a CAN bus 21.

The vehicle control apparatus 17 acquires information from various kinds of sensors such as the rear-wheel resolver 13, an accelerator pedal sensor 22, which detects an accelerator operation amount, a brake sensor 23, which detects a brake operation amount, and a gear position sensor 24, and comprehensively controls the vehicle. The vehicle control apparatus 17 outputs a driver request torque that the rear motor 7 should output according to a request distribution torque in response to a request torque according to an accelerator operation, a brake operation, or the like of the driver.

The brake control apparatus 18 acquires information from various kinds of sensors such as the brake sensor 23 to set a target braking torque, which is a torque converted value of a target braking force of the vehicle, to generate the brake hydraulic pressure required for each wheel according to the target braking torque to output it to the frictional brake 3 via a hydraulic pipe 18a.

The battery control apparatus 19 monitors a charged/discharged state of the high-voltage battery 15 and a cell constituting the high-voltage battery 15. The battery control apparatus 19 calculates a battery request torque limit value based on the charged/discharged state of the high-voltage battery 15 or the like. The battery request torque limit value is a maximum torque allowed for the rear motor 7. For example, when the charged capacity of the high-voltage battery 15 is lowered, the battery request torque limit value is set to a smaller value than normal.

The rear motor control apparatus 20 controls electric power to supply to the rear motor 7 based on a rear request torque.

The electric vehicle 1 according to the first embodiment performs anti-jerk control of causing the rear motor 7 to output a driving torque corresponding to a total braking torque determined by estimating a braking torque actually generated on the vehicle when the vehicle stops, with the aim of suppressing an unpleasant vibration of the vehicle when the vehicle stops to thus ease fatigue of a passenger. As a result, a longitudinal jerk (jolt) that occurs when the vehicle stops with a predetermined brake operation amount can be reduced by approximately 68% compared to when the anti-jerk control is absent. In other words, the vehicle can smoothly stop even in the absence of a skillful brake operation.

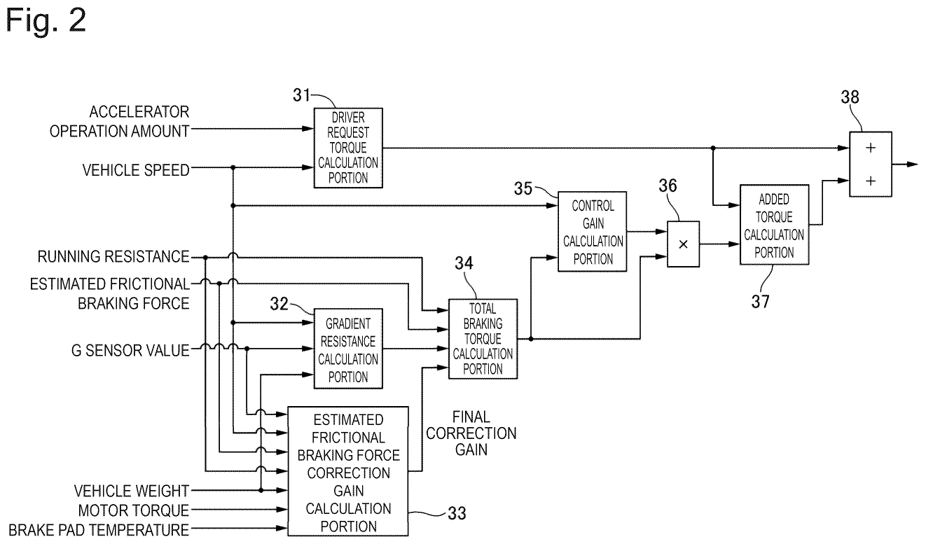

FIG. 2 is a control block diagram of the rear motor 7 according to the first embodiment.

A driver request torque calculation portion 31 calculates the driver request torque based on the accelerator operation amount and a vehicle speed.

A gradient resistance calculation portion 32 calculates gradation resistance, which is resistance acting on the vehicle due to a gradient of a road surface, based on the vehicle speed, the G sensor value, and a vehicle weight. More specifically, the gradient resistance calculation portion 32 determines an estimated gradient acceleration generated due to the gradient based on a deviation between a differential value of the vehicle speed and the G sensor value, and calculates the gradient resistance based on the estimated gradient acceleration generated due to the gradient and the vehicle weight.

An estimated frictional braking force correction gain calculation portion 33 calculates a final correction gain for correcting an estimation error of an estimated frictional braking force that occurs along with a change in a pad μ (a frictional coefficient) based on the G sensor value, the vehicle speed, the estimated frictional braking force, a running resistance, the vehicle weight, a motor torque, and a brake pad temperature. When the pad μ changes due to, for example, a temperature change or a humidity change, the estimated frictional force deviates from the braking force actually generated on the vehicle by the brake.

Therefore, the pad μ is estimated, and a gain for correcting the estimated frictional braking force (a torque converted value thereof) is calculated to cancel out an error in an estimated pad μ from a nominal value of the pad μ.

The estimated frictional braking force is calculated as a sum of the respective estimated frictional braking forces of the wheels. The estimated frictional braking force Bi of each wheel is calculated using the following equation (1).

estimated frictional braking force Bi of each wheel=brake hydraulic pressure×cylinder area×brake effective radius×pad μ (nominal value) (1)

In this case, the nominal value of the pad μ is kept constant while the vehicle is running once it is set. The nominal value is set by acquiring a temperature −μ characteristic of the brake pad as a map in advance and referring to the map. The temperature of the brake pad when the nominal value is calculated may be an external temperature when the vehicle starts running, or a predefined temperature (for example, 20 °C) may be used.

The running resistance may be determined by acquiring a change in the running resistance with respect to a change in the vehicle weight or the vehicle speed in advance and calculating the running resistance based thereon, or estimating the running resistance.

The estimated frictional braking force may be estimated based on a driver's stroke amount of the brake pedal instead of the brake hydraulic pressure.

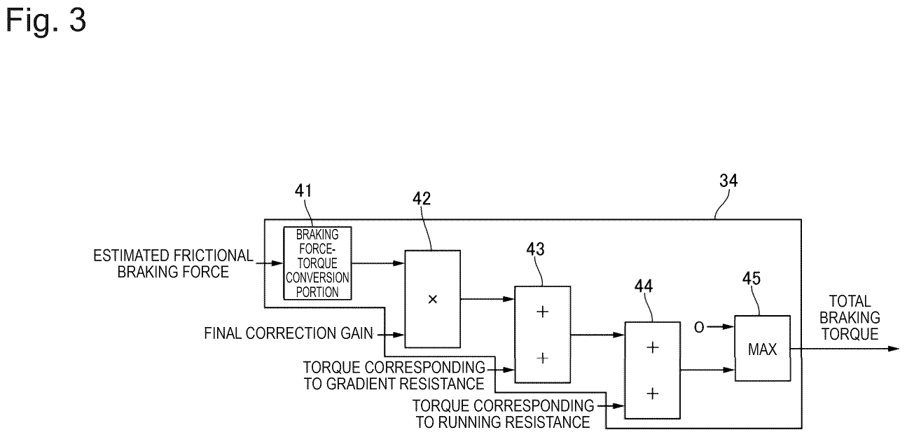

A total braking torque calculation portion 34 calculates the total braking torque based on the running resistance, the estimated frictional braking force, the gradient resistance, and the final correction gain. FIG. 3 is a control block diagram of the total braking torque calculation portion 34 according to the first embodiment. A braking force-torque conversion portion 41 converts the estimated frictional braking force into an estimated frictional braking torque. A multiplier 42 calculates an after-correction estimated frictional braking torque resulting from correcting the estimation error that occurs along with the change in u of the brake pad by multiplying the estimated frictional braking torque by the final correction gain. A first adder 43 and a second adder 44 add a torque corresponding to the gradient resistance and a torque corresponding to the running resistance to the after-correction estimated frictional braking torque. A limiter 45 compares a value resulting from adding the torque corresponding to the gradient resistance and the torque corresponding to the running resistance to the after-correction estimated frictional braking torque, and zero, and outputs one of them that has a larger value as the total braking torque.

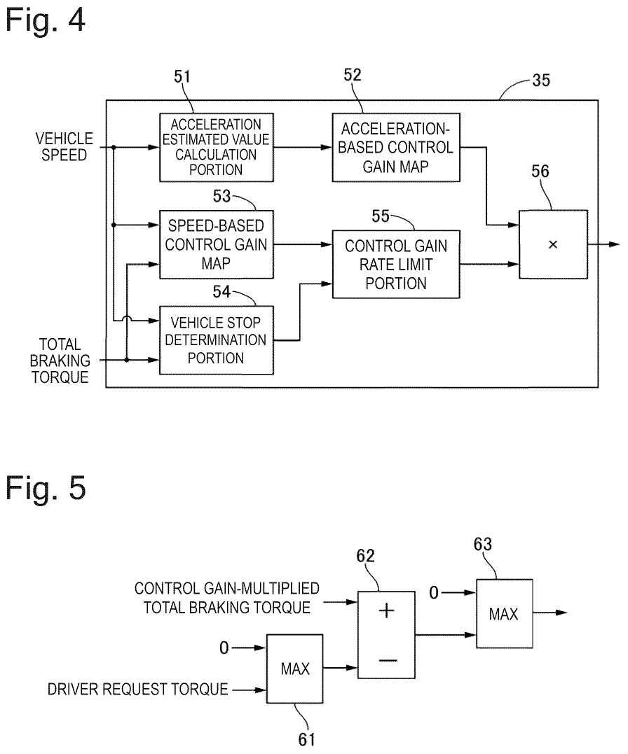

A control gain calculation portion 35 calculates a control gain based on the vehicle speed and the total braking torque. FIG. 4 is a control block diagram of the control gain calculation portion 35 according to the first embodiment. An acceleration estimated value calculation portion 51 calculates an acceleration by differentiating the vehicle speed. An acceleration-based control gain map 52 sets an acceleration-based control gain according to the acceleration. The acceleration-based control gain map 52 sets the acceleration-based control gain to 1(100 %) if a deceleration smaller than a predefined value×2 (G) as the absolute value is generated while gradually reducing the acceleration-based control gain as the absolute value of the deceleration increases if a deceleration equal to or greater than the predefined value×2 (G) as the absolute value is generated. The minimum value of the acceleration-based control gain is set to zero (0%). This setting can prevent the torque from being added at the time of sudden braking. It goes without saying that it is more desirable to secure the braking force than suppressing a vibration in the pitching direction at the time of sudden braking.

A speed-based control gain map (a gain characteristic map) 53 sets a speed-based control gain (a control gain) according to the vehicle speed (a physical quantity relating to a speed of a vehicle) and the total braking torque (a physical quantity relating to a total braking force). The details of the speed-based control gain map 53 will be described below. A vehicle stop determination portion 54 calculates a time taken until the vehicle stops based on the present vehicle speed and the total braking torque per control cycle, and clears a vehicle stop determination flag (=0) unless the time taken until the vehicle stops is zero and sets the vehicle stop determination flag (=1) when the time taken until the vehicle stops becomes zero. A control gain rate limit portion 55 limits the speed of a change in the speed-based control gain on an increase side and a reduction side. Further, when the vehicle stop determination flag is set (=1), the control gain rate limit portion 55 changes the change speed limit value on the reduction side used until that. Alternatively, the timings of clearing and setting the vehicle stop determination flag may be such timings that the vehicle stop determination flag is set when the time taken until the vehicle stops is equal to or shorter than a predefined value and is cleared when the time taken until the vehicle stops is equal to or longer than the predefined value, instead of the timings when the time taken until the vehicle stops becomes zero.

A multiplier 56 outputs a value resulting from multiplying the acceleration-based control gain by the speed-based control gain as the final control gain. A multiplier 36 calculates a control gain-multiplied total braking torque by multiplying the total braking torque by the control gain. An added torque calculation portion 37 calculates an added torque as an anti-jerk control torque based on the driver request torque and the control gain-multiplied total braking torque. FIG. 5 is a control block diagram of the added torque calculation portion 37 according to the first embodiment. A limiter 61 compares the driver request torque and zero, and outputs one of them that has a larger value. A comparator 62 subtracts the output of the limiter 61 from the control gain-multiplied total braking torque.

A limiter 63 compares the output of the comparator 62 and zero, and outputs one of them that has a larger value as the added torque.

An adder 38 sets an after-addition torque resulting from adding the added torque to the driver request torque as the rear request torque.

Next, the speed-based control gain map 53 according to the first embodiment will be described in detail.

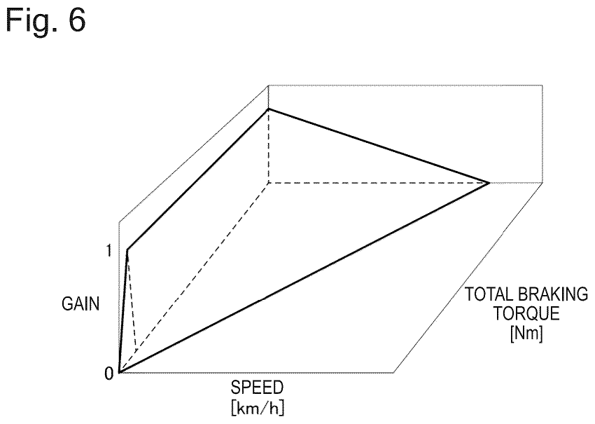

FIG. 6 illustrates a gain characteristic of the speed-based control gain map 53 according to the first embodiment.

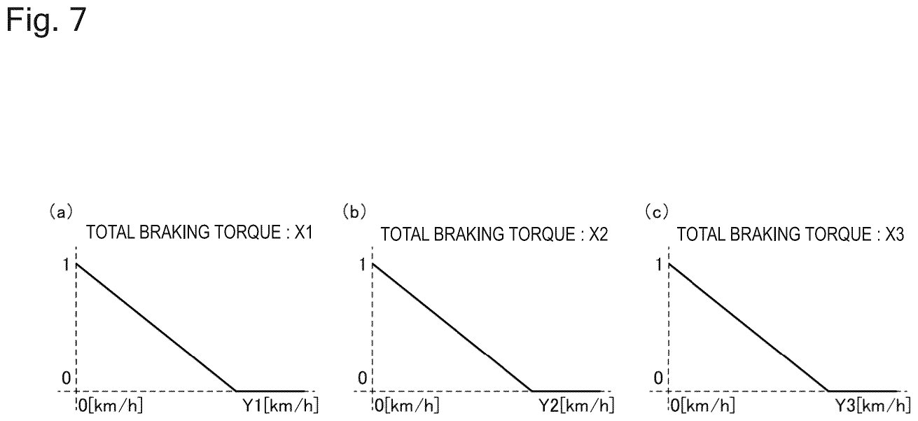

The speed-based control gain map 53 is a three-dimensional map into which the vehicle speed and the total braking torque are input and from which the speed-based control gain is output. The speed-based control gain has a characteristic of linearly reducing as the total braking torque reduces only in a predetermined region where the total braking torque is around zero, and being kept at a maximum value 1 in most regions exceeding the predetermined region. The maximum value may be set to a positive value different from 1. Further, the speed-based control gain is set so as to linearly increase as the vehicle speed reduces. Then, as also illustrated in FIG. 7, the speed-based control gain is set in such a manner that a vehicle speed at which the value rises from zero (a gain increase start speed) increases as the total braking torque increases. In other words, the speed-based control gain has such a characteristic that the vehicle speed at which an anti-jerk control instruction intervenes (the vehicle speed at which the generation of the driving force by the anti-jerk control is started) increases as the total braking torque increases.

In the first embodiment, in FIG. 7, the gain increase start speed is Y1>Y2>Y3 when the total braking torque is |X1|>|X2|>|X3|, and, further, Y1, Y2, and Y3 are in such a relationship that Y1 is three times Y3 and Y2 is twice Y3 when |X1|, |X2|, and |X3| are in such a relationship that |X1| is three times |X3| and |X2| is twice |X3|. In other words, the speed-based control gain has such a characteristic that the vehicle speed at which the anti-jerk control instruction intervenes linearly increases as the total braking torque increases. This allows a similar deceleration feeling to be maintained along with the reduction in the vehicle speed for any total braking torque regardless of the magnitude of the total braking force, thereby contributing to easing an uncomfortable feeling inflicted on the driver as a result thereof. One possible example is that X1, X2, and X3 are set to total braking torques of approximately −0.3 [G], −0.2 [G], and −0.1 [G], respectively, and Y1, Y2, and Y3 are set to 3 [km/h], 2 [km/h], and 1 [km/h], respectively. The speed-based control gain is set in such a manner that the value thereof linearly increases with respect to the reduction in the vehicle speed for each total braking torque in the first embodiment, but may be set to such a characteristic that the value thereof increases slowly when the vehicle speed is high and increases by a larger amount as the vehicle speed reduces.

Next, advantageous effects of the first embodiment will be described.

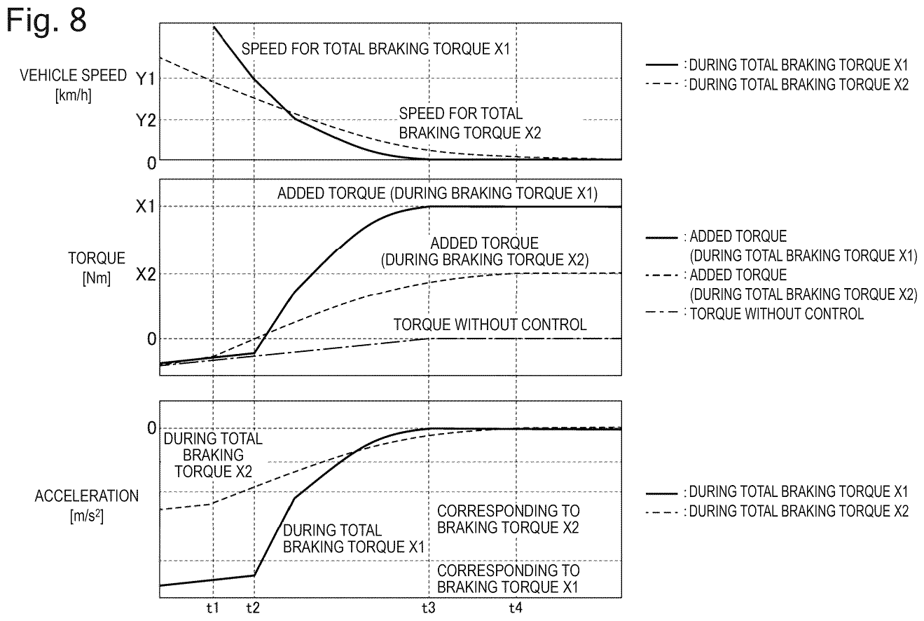

FIG. 8 illustrates time charts of the vehicle speed, the rear motor torque, and the vehicle longitudinal acceleration when the control gain in the anti-jerk control is set only according to the vehicle speed, and the vehicle speed at which the generation of the driving force is started is kept constant regardless of the magnitude of the total braking torque, as a comparison example compared with the first embodiment. This comparison example increases the control gain according to the reduction in the vehicle speed consistently when the vehicle speed reaches Y1 [km/h]. In the case where the total braking torque is X1 [Nm], the increase in the torque by the anti-jerk control is started at time t2, and the vehicle stops at time t4. On the other hand, in the case where the total braking torque is X2 [Nm] (<X1), the increase in the torque by the anti-jerk control is started at time t1, and the vehicle stops at time t3. Therefore, the acceleration characteristic of the vehicle until the vehicle stops is different for each total braking torque in the comparison example. In other words, the deceleration feeling is different for each total braking torque, which may inflict an uncomfortable feeling on the driver. More specifically, when the deceleration is subtracted early despite a relatively small total braking torque or the increase in the torque is started at a low speed despite a relatively great total braking torque, the driver may undesirably feel an uncomfortable feeling.

On the other hand, the vehicle control apparatus 17 according to the first embodiment changes the vehicle speed at which the anti-jerk control instruction intervenes based on the total braking torque. More specifically, a higher speed is set as the vehicle speed at which the anti-jerk control instruction intervenes as the total braking torque increases. In the case where the total braking torque is X1 [Nm], the increase in the torque by the anti-jerk control is started at time t1, and the vehicle stops at time t3. In the case where the total braking torque is X2 [Nm], the increase in the torque by the anti-jerk control is started at time t2, and the vehicle stops at time t3. In other words, the vehicle control apparatus 17 according to the first embodiment allows the acceleration characteristic that the vehicle exhibits until the vehicle stops to resemble more closely to a preset intended characteristic regardless of the total braking torque. As a result, a smooth vehicle stop can be realized without causing the driver to develop an uncomfortable feeling regardless of the request braking force.

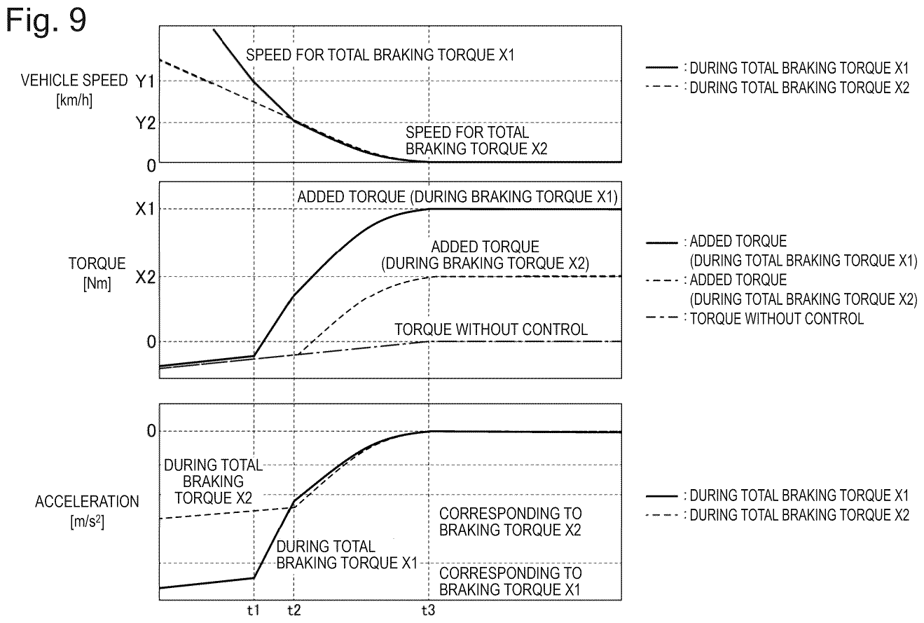

At this time, the vehicle control apparatus 17 linearly increases the vehicle speed at which the anti-jerk control instruction intervenes as the total braking torque increases. This allows the acceleration to change evenly for each total braking torque as illustrated in time charts of FIG. 9, thereby contributing to realizing an intended smooth vehicle stop. In other words, the anti-jerk control according to the first embodiment allows the constant excellent deceleration feeling to be maintained consistently regardless of the total braking force, thereby contributing to easing the uncomfortable feeling inflicted on the driver.

The vehicle control apparatus 17 outputs the speed-based control gain based on the speed-based control gain map 53 that is a three-dimensional map prepared in advance, into which the total braking torque and the vehicle speed are input and from which the speed-based control gain is output, and changes the anti-jerk control instruction based on the speed-based control gain. As a result, the vehicle control apparatus 17 can acquire an optimum speed-based control gain for realizing a desired acceleration characteristic according to the total braking torque and the vehicle speed.

In the speed-based control gain map 53, the speed-based control gain linearly increases as the vehicle speed reduces. As a result, the driving force can be effectively generated under conditions other than sudden deceleration and immediately before the vehicle stops.

### Second Embodiment

A second embodiment has a basic configuration similar to the first embodiment, and therefore will be described focusing on only differences from the first embodiment.

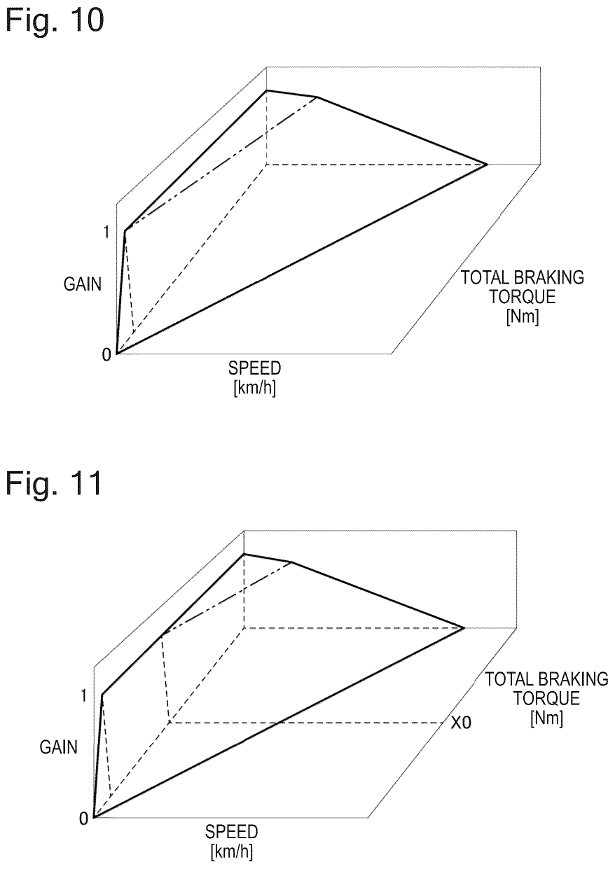

FIG. 10 illustrates a gain characteristic of the speed-based control gain map 53 according to the second embodiment. The speed-based control gain is set in such a manner that the change gradient of the speed-based control gain with respect to the vehicle speed is two-staged for each total braking torque. More specifically, the speed-based control gain is set in such a manner that the change rate of the speed-based control gain with respect to the change in the vehicle speed is lower in a region where the vehicle speed is around zero than in other regions. The speed-based control gain is set in such a manner that the change rate of the speed-based control gain is switched at a higher vehicle speed as the total braking torque increases. The speed-based control gain may be set in such a manner that the increase gradient of the speed-based control gain gradually reduces as the vehicle speed reduces. This makes it easier to return the pitch angle of the vehicle generated due to braking to zero by the time the vehicle stops, thereby contributing to further suppressing the shock when the vehicle stops.

### Third Embodiment

A third embodiment has a basic configuration similar to the first embodiment, and therefore will be described focusing only on differences from the first embodiment.

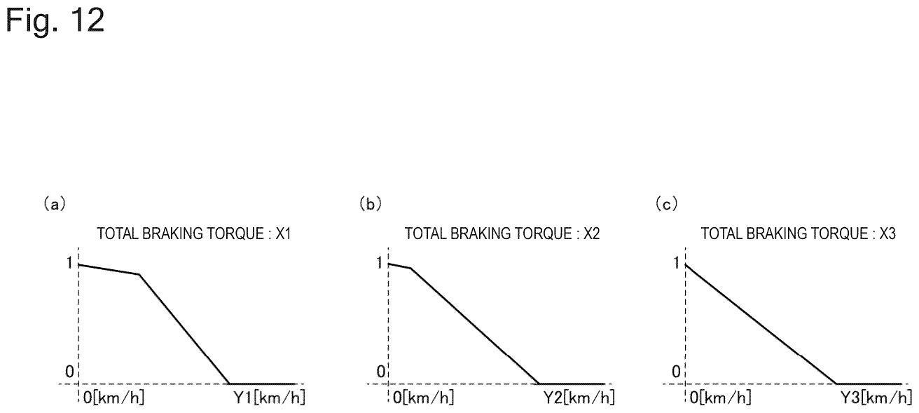

FIG. 11 illustrates a gain characteristic of the speed-based control gain map 53 according to the second embodiment. The speed-based control gain is set in such a manner that, only in a region where the total braking torque is greater than a predetermined value X0, the change rate of the speed-based control gain with respect to the change in the vehicle speed is lower in the region where the vehicle speed is around zero than in other regions. In a region where the total braking torque is equal to or smaller than the predetermined value X0, the speed-based control gain linearly changes with respect to the vehicle speed. FIG. 12 illustrates the gain characteristic of the speed-based control gain map 53 with respect to the vehicle speed according to the third embodiment, and indicates an example in a case of |X1|>|X2|>X0|>X3|. The speed-based control gain may be set in such a manner that the increase gradient of the speed-based control gain gradually reduces as the vehicle speed reduces in the region where the total braking torque is greater than a predetermined value T1.

When the total braking torque is relatively great, the pitch angle generated due to the braking force also increases, and therefore increasing the speed-based control gain early brings about a significant effect of applying a high torque for a long time to reduce the pitch angle to zero. On the other hand, when the total braking torque is small, the pitch angle generated due to the braking force reduces, and therefore the time taken to return the pitch angle to zero is expected to reduce as well, and thus the gain characteristic may be set to a linear characteristic.

### Fourth Embodiment

A fourth embodiment has a basic configuration similar to the first embodiment, and therefore will be described focusing on only differences from the first embodiment.

A vehicle control system according to the fourth embodiment performs anti-jerk control of reducing the frictional braking force from a frictional braking force serving as a reference (a reference frictional braking force) with the aim of suppressing an unpleasant vibration of the vehicle when the vehicle stops and easing passenger's fatigue. The reference frictional braking force here is an estimated frictional braking force estimated based on the stroke amount of the brake pedal.

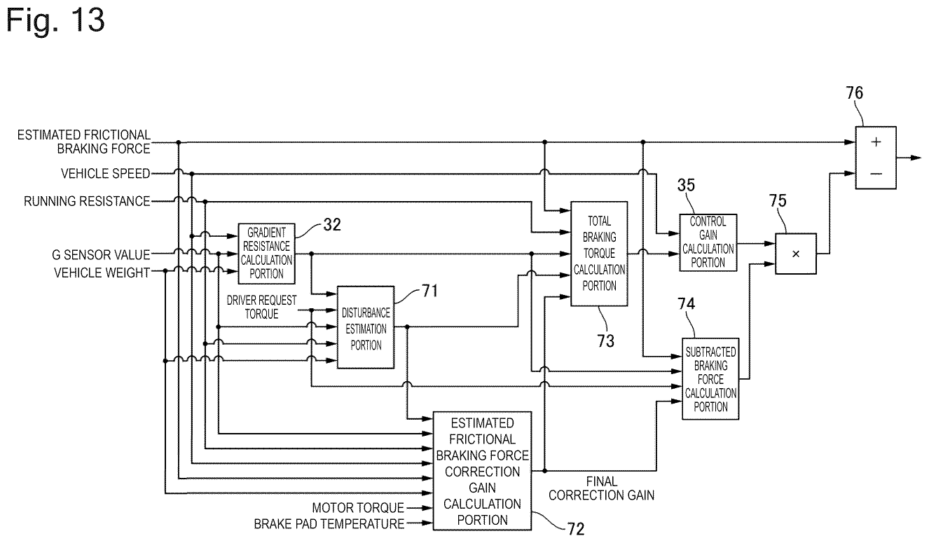

FIG. 13 is a control block diagram of the frictional brake 3 according to the fourth embodiment.

A disturbance estimation portion 71 estimates a disturbance based on the gradient resistance, the driver request torque, the G sensor value, the running resistance, and the vehicle weight. The disturbance is estimated using the following equation (2) basically when the brake is not in use.

disturbance=G sensor value×vehicle weight−braking/driving force corresponding to driver request torque−gradient resistance−running resistance (2)

The frictional brake 3 may be configured to estimate the disturbance even when the influence of the change in the pad μ is small, such as when the estimated frictional braking force is extremely small.

An estimated frictional braking force correction gain calculation portion 72 calculates the final correction gain for correcting the estimation error of the estimated frictional braking force that occurs along with the change in the pad μ (the frictional coefficient) based on the disturbance, the G sensor value, the running resistance, the vehicle speed, the estimated frictional braking force, the vehicle weight, the motor torque, and the brake pad temperature. The estimated frictional braking force correction gain calculation portion 72 calculates the final correction gain by a similar method to the estimated frictional braking force correction gain calculation portion 33 according to the first embodiment, but calculates the estimated frictional braking force correction gain for further correcting an error derived from the disturbance.

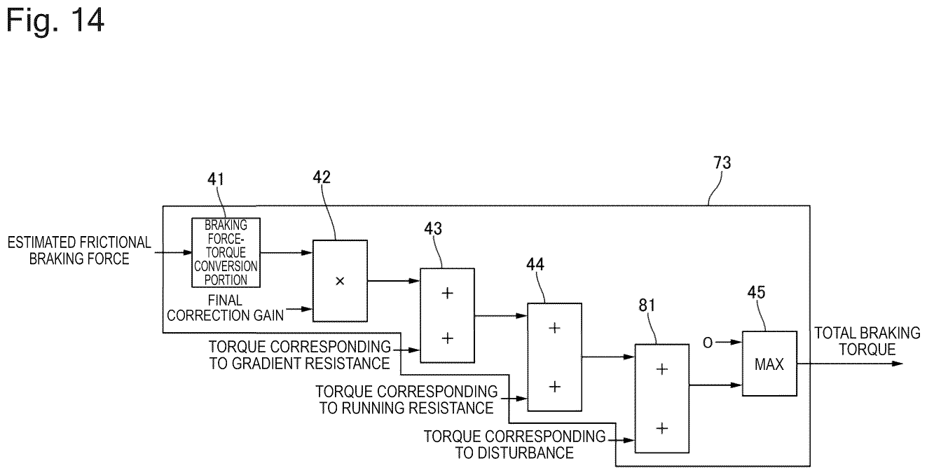

A total braking torque calculation portion 73 calculates the total braking torque based on the estimated frictional braking force, the running resistance, the gradient resistance, the disturbance, and the final correction gain. FIG. 14 is a control block diagram of the total braking torque calculation portion 73 according to the fourth embodiment. A third adder 81 adds a torque corresponding to the disturbance to the value resulting from adding the torque corresponding to the gradient resistance and the torque corresponding to the running resistance to the after-correction estimated frictional braking torque.

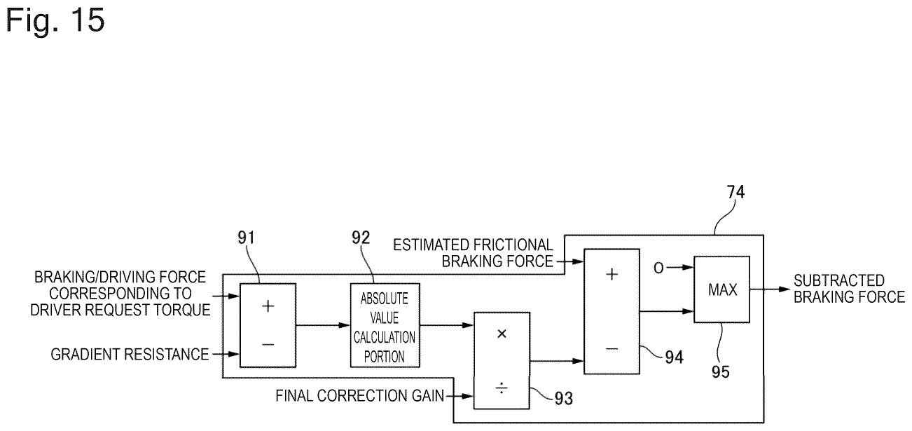

A subtracted braking force calculation portion 74 calculates a subtracted braking force based on the estimated frictional braking force, the disturbance, the driver request torque, and the final correction gain. FIG. 15 is a control block diagram of the subtracted braking force calculation portion 74 according to the fourth embodiment. A comparator 91 calculates a braking/driving force corresponding to the driver request torque in consideration of the gradient resistance by subtracting the gradient resistance from the braking/driving force corresponding to the driver request torque. An absolute value calculation portion 92 calculates an absolute value of the output of the comparator 91. A multiplier 93 calculates a braking/driving force absolute value corresponding to an after-correction driver request torque by dividing the output of the absolute value calculation portion 92 by the final correction gain. A comparator 94 subtracts the braking/driving force absolute value corresponding to the after-correction driver request torque from the estimated frictional braking force. A limiter 95 compares a value resulting from subtracting the braking/driving force absolute value corresponding to the after-correction driver request torque from the estimated frictional braking force, and zero, and outputs one of them that has a larger value as a subtracted braking force.

A multiplier 75 calculates a control gain-multiplied subtracted braking force by multiplying the subtracted braking force by the control gain. A comparator 76 calculates an after-subtraction frictional braking force by subtracting the control gain-multiplied subtracted braking force from the estimated frictional braking force. The brake control apparatus 18 sets an after-subtraction frictional braking torque, which is a torque converted value of the after-subtraction frictional braking force, as a target braking torque.

Next, advantageous effects of the fourth embodiment will be described.

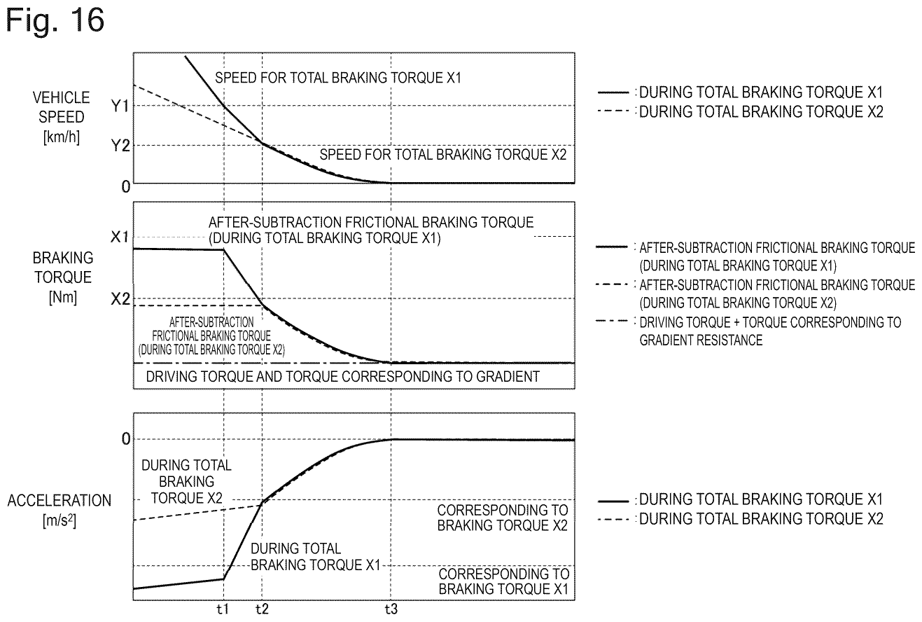

FIG. 16 illustrates time charts of the vehicle speed, the braking torque, and the vehicle longitudinal acceleration when the disturbance does not occur in the anti-jerk control according to the fourth embodiment.

In the fourth embodiment, the vehicle speed at which the anti-jerk control instruction intervenes is also set so as to linearly increase as the total braking torque increases. In the case where the total braking torque is X1 [Nm], the reduction in the braking torque by the anti-jerk control is started at time t1, and the vehicle stops at time t3.

In the case where the total braking torque is X2 [Nm], the reduction in the braking torque by the anti-jerk control is started at time t2, and the vehicle stops at time t3. This also allows the constant excellent deceleration feeling to be maintained consistently regardless of the total braking force, thereby contributing to easing the uncomfortable feeling inflicted on the driver, similarly to the first embodiment.

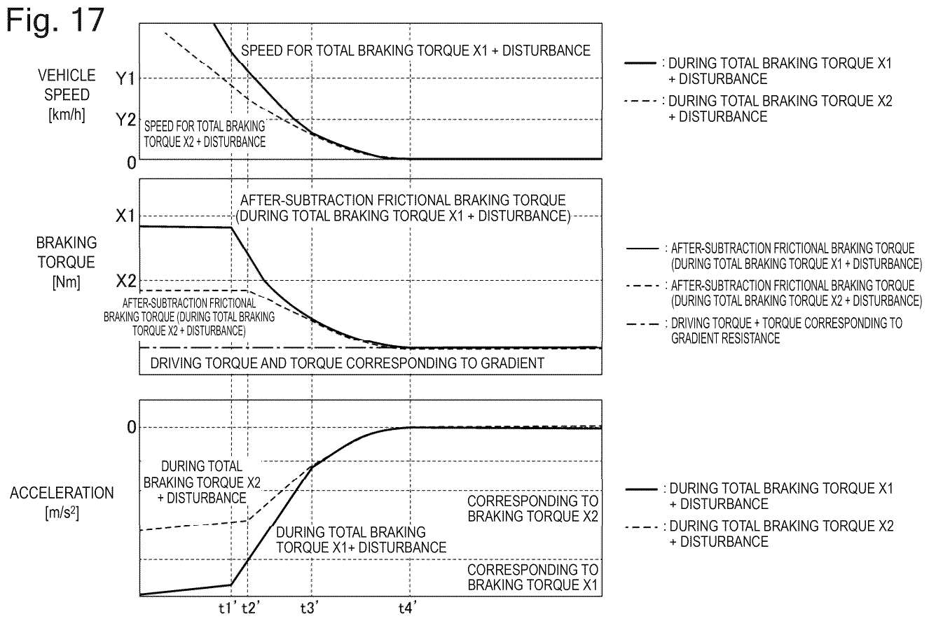

FIG. 17 illustrates time charts of the vehicle speed, the braking torque, and the vehicle longitudinal acceleration when the disturbance occurs in the anti-jerk control according to the fourth embodiment.

In the control gain calculation portion 35, the speed-based control gain calculated according to the total braking torque is set in such a manner that the gain increase start speed increases as the total braking torque increases. Then, in the fourth embodiment, the total braking torque calculation portion 73 calculates the total braking torque in consideration of the disturbance. Therefore, the gain increase start speed of the speed-based control gain changes according to the magnitude of the disturbance. In the case where the total braking torque is X1 [Nm], the reduction in the braking torque by the anti-jerk control is started at time t1′, and the vehicle stops at time t3. In the case where the total braking torque is X2 [Nm], the reduction in the braking torque by the anti-jerk control is started at time t2′, and the vehicle stops at time t3. In this manner, the fourth embodiment calculates the total braking torque in consideration of even the disturbance, thereby allowing the anti-jerk control to intervene since a further suitable gain increase start speed, thereby contributing to improving the ride comfort regardless of the disturbance.

### Other Embodiments

Having described the embodiments for implementing the present invention, the specific configuration of the present invention is not limited to the configurations of the embodiments, and the present invention also includes a design modification and the like thereof made within a range that does not depart from the spirit of the present invention, if any.

The estimated frictional braking force is fed as the input in the embodiments, but the estimated frictional braking torque may be input because the braking force and the braking torque are convertible values using a vehicle parameter such as the effective radius of the tire, and the effective radius of the tire at this time may be estimated instead of being a predefined value.

Further, the output in the first to third embodiments is yielded as the driving torque, but the output may be the driving force, which is a convertible value using the tire effective radius similarly to the relationship between the braking force and the braking torque, or may be the longitudinal acceleration or the longitudinal jerk convertible using a vehicle parameter such as the vehicle weight.

Further, the output in the fourth embodiment is yielded as the braking force, but may be the estimated frictional braking torque because they are convertible values using a vehicle parameter such as the effective radius of the tire, or may be the longitudinal acceleration or the longitudinal jerk convertible using a vehicle parameter such as the vehicle weight.

The embodiments have been described citing the example in which the present invention is applied to the rear-wheel drive electric vehicle, but the present invention may also be applied to a front-wheel drive electric vehicle or a four-wheel drive electric vehicle. Further, without being limited to the electric vehicle, the present invention may also be applied to a vehicle equipped with an engine that is an internal combustion engine, or a hybrid vehicle runnable using both an engine and a motor. In other words, the present invention can be applied to any configuration capable of providing a torque from a drive source side or any configuration capable of reducing frictional brake within a range in which the vehicle can stop or a range in which a braking force works between a drive wheel and a road surface when the vehicle stops using the frictional brake.

The vehicle weight may be detected by a sensor such as a height sensor of the suspension or may be estimated.

In the first to fourth embodiments, the speed-based control gain map may be configured in such a manner that a plurality of speed-based control gain maps is prepared according to the vehicle weight and an appropriate map is selected. Further, the speed-based control gain map is formed in such a manner that the gain reaches 1 when the speed becomes zero even when the total braking torque is great in the first to fourth embodiments, but may be formed into such a map that the maximum value of the gain reduces as the total braking torque increases when the total braking torque is equal to or greater than a predefined value.

As the brake pad temperature, the temperature of the brake pad may be acquired using a sensor, or a change in the pad temperature may be estimated per time.

In the fourth embodiment, the disturbance may be estimated by detecting how much the road surface is roughened using a stereo camera or the like. Further, the vehicle control apparatus 17 may be configured to start subtracting the braking force earlier than the intervention for the braking torque applied under normal conditions, if an increase in the disturbance is expected due to the road surface after the condition of the road surface is detected using the stereo camera or the like.

The present invention shall not be limited to the above-described embodiments, and includes various modifications. For example, the above-described embodiments have been described in detail to facilitate a better understanding of the present invention, and the present invention shall not necessarily be limited to the configuration including all of the described features. Further, a part of the configuration of some embodiment can be replaced with the configuration of another embodiment. Further, some embodiment can also be implemented with a configuration of another embodiment added to the configuration of this embodiment. Further, each embodiment can also be implemented with another configuration added, deleted, or replaced with respect to a part of the configuration of this embodiment.

The present application claims priority under the Paris Convention to Japanese Patent Application No. 2022-138912 filed on Sep. 1, 2022. The entire disclosure of Japanese Patent Application No. 2022-138912 filed on Sep. 1, 2022 including the specification, the claims, the drawings, and the abstract is incorporated herein by reference in its entirety.

### REFERENCE SIGNS LIST

1 electric vehicle (vehicle)
3 frictional brake (frictional braking apparatus)
7 rear motor (driving apparatus)
17 vehicle control apparatus (control portion)

1. A vehicle control apparatus mounted on a vehicle, the vehicle including a frictional braking apparatus configured to generate a frictional braking force on the vehicle and a driving apparatus configured to generate a driving force on the vehicle, the vehicle control apparatus comprising:
a control portion configured to output a result calculated based on input information,
the control portion being configured to
acquire a physical quantity relating to a speed of the vehicle,
acquire a physical quantity relating to a total braking force for decelerating the vehicle, and
change the physical quantity relating to the speed of the vehicle at which a control instruction intervenes based on the physical quantity relating to the total braking force, when outputting the control instruction for generating the driving force by the driving apparatus in a state that the frictional braking force is generated at the time of deceleration of the vehicle based on the physical quantity relating to the total braking force.

2. The vehicle control apparatus according to claim 1, wherein the control portion increases the physical quantity relating to the speed of the vehicle at which the control instruction intervenes as the physical quantity relating to the total braking force increases.

3. The vehicle control apparatus according to claim 2, wherein the control portion linearly increases the physical quantity relating to the speed of the vehicle at which the control instruction intervenes as the physical quantity relating to the total braking force increases.

4. The vehicle control apparatus according to claim 1, wherein the control portion outputs a control gain based on a gain characteristic map prepared in advance, into which the physical quantity relating to the total braking force and the physical quantity relating to the speed of the vehicle are input and from which the gain is output, and changes the control instruction based on the control gain.

5. The vehicle control apparatus according to claim 4, wherein the gain characteristic map is a three-dimensional map into which the physical quantity relating to the total braking force and the physical quantity relating to the speed of the vehicle are input and from which the gain is output.

6. The vehicle control apparatus according to claim 4, wherein the control gain is set so as to linearly increase as the physical quantity relating to the speed of the vehicle reduces.

7. The vehicle control apparatus according to claim 4, wherein the control gain is set in such a manner that an increase gradient of the control gain gradually reduces as the physical quantity relating to the speed of the vehicle reduces.

8. The vehicle control apparatus according to claim 4, wherein the control gain is set in such a manner that an increase gradient of the control gain gradually reduces as the physical quantity relating to the speed of the vehicle reduces when the physical quantity relating to the total braking force is greater than a predetermined value, and is set so as to linearly increase as the physical quantity relating to the speed of the vehicle reduces when the physical quantity relating to the total braking force is equal to or smaller than the predetermined value.

9. The vehicle control apparatus according to claim 4, wherein the control gain is set in such a manner that an increase gradient of the control gain gradually increases as the physical quantity relating to the speed of the vehicle reduces.

10. A vehicle control apparatus mounted on a vehicle, the vehicle including a frictional braking apparatus configured to generate a frictional braking force on the vehicle and a driving apparatus configured to generate a driving force on the vehicle, the vehicle control apparatus comprising:
a control portion configured to output a result calculated based on input information,
the control portion being configured to
acquire a physical quantity relating to a speed of the vehicle,
acquire a physical quantity relating to a total braking force for decelerating the vehicle,
acquire a physical quantity relating to a disturbance influential on a behavior of the vehicle, and
change the physical quantity relating to the speed of the vehicle at which a control instruction intervenes based on a magnitude of the physical quantity relating to the total braking force and the physical quantity relating to the disturbance, when outputting the control instruction for increasing the driving force by the driving apparatus or reducing the frictional braking force from a reference frictional braking force by the frictional braking apparatus at the time of deceleration of the vehicle based on the physical quantity relating to the total braking force.

11. A vehicle control method configured to be performed by a control unit mounted on a vehicle, the vehicle including a frictional braking apparatus configured to generate a frictional braking force on the vehicle and a driving apparatus configured to generate a driving force on the vehicle, the vehicle control method comprising:
causing the control unit to
acquire a physical quantity relating to a speed of the vehicle,
acquire a physical quantity relating to a total braking force for decelerating the vehicle, and
change the physical quantity relating to the speed of the vehicle at which a control instruction intervenes based on the physical quantity relating to the total braking force, when outputting the control instruction for generating the driving force by the driving apparatus in a state that the frictional braking force is generated at the time of deceleration of the vehicle based on the physical quantity relating to the total braking force.

12. A vehicle control system comprising:
a frictional braking apparatus configured to generate a frictional braking force on a vehicle:
a driving apparatus configured to generate a driving force on the vehicle; and
a control apparatus configured to output a result calculated based on input information, the control apparatus being configured to
acquire a physical quantity relating to a speed of the vehicle,
acquire a physical quantity relating to a total braking force for decelerating the vehicle, and
change the physical quantity relating to the speed of the vehicle at which a control instruction intervenes based on the physical quantity relating to the total braking force, when outputting the control instruction for generating the driving force by the driving apparatus in a state that the frictional braking force is generated at the time of deceleration of the vehicle based on the physical quantity relating to the total braking force.
